(19) United States
(12) Patent Application Publication
(10) Pub. No.: US 2024/0104344 A1
(43) Pub. Date: Mar. 28, 2024

(54) HYBRID-CONDITIONAL ANOMALY DETECTION

(71) Applicants: NEC Laboratories America, Inc., Princeton, NJ (US); NEC Corporation, Tokyo (JP)

(72) Inventors: LuAn Tang, Cranbury, NJ (US); Peng Yuan, Princeton, NJ (US); Yuncong Chen, Plainsboro, NJ (US); Haifeng Chen, West Windsor, NJ (US); Yuji Kobayashi, Minato-ku (JP); Jiafan He, Los Angeles, CA (US)

(21) Appl. No.: 18/467,069

(22) Filed: Sep. 14, 2023

Related U.S. Application Data
(60) Provisional application No. 63/407,542, filed on Sep. 16, 2022.
(60) Provisional application No. 63/468,294, filed on May 23, 2023.

(51) Int. Cl. G06N 3/0442

(52) U.S. Cl. CPC G06N 3/0442

(57) ABSTRACT

Methods and systems for training a model include distinguishing hidden states of a monitored system based on condition information. An encoder and decoder are generated for each respective hidden state using forward and backward autoencoder losses. A hybrid hidden state is determined for an input sequence based on the hidden states. The input sequence is reconstructed using the encoders and decoders and the hybrid hidden state. Parameters of the encoders and decoders are updated based on a reconstruction loss.

### RELATED APPLICATION INFORMATION

This application claims priority to U.S. Patent Application No. 63/407,542, filed on Sep. 16, 2022, and to U.S. Patent Application No. 63/468,294, filed on May 23, 2023, each incorporated herein by reference in its entirety.

### BACKGROUND

### Technical Field

The present invention relates to system monitoring and, more particularly, to anomaly detection in systems with hidden conditions.

### Description of the Related Art

A cyber-physical system may include a variety of sensors, which may collect a wide variety of information about the system, its operation, and its environment. The collected data may be used to characterize the operational characteristics of the cyber-physical system, for example to determine when the cyber-physical system may be operating outside its expected normal parameters.

### SUMMARY

A method for training a model includes distinguishing hidden states of a monitored system based on condition information. An encoder and decoder are generated for each respective hidden state using forward and backward autoencoder losses. A hybrid hidden state is determined for an input sequence based on the hidden states. The input sequence is reconstructed using the encoders and decoders and the hybrid hidden state. Parameters of the encoders and decoders are updated based on a reconstruction loss.

A system for training a model includes a hardware processor and a memory that stores a computer program. When executed by the hardware processor, the computer program causes the hardware processor to distinguish hidden states of a monitored system based on condition information, to generate an encoder and decoder for each respective hidden state using forward and backward autoencoder losses, to determine a hybrid hidden state for an input sequence based on the hidden states, to reconstruct the input sequence using the encoders and decoders and the hybrid hidden state, and to update parameters of the encoders and decoders based on a reconstruction loss.

A method for anomaly detection includes generating a hybrid hidden state for an input sequence relative to hidden states of a system. The input sequence is reconstructed using a decoder, based on the hybrid hidden state. An anomaly score is determined based on a reconstruction error between the input sequence and the reconstructed input sequence. A corrective action is performed responsive to the anomaly score.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a diagram of a cyber-physical system that performs anomaly detection responsive to hidden conditions of the system, in accordance with an embodiment of the present invention;

FIG. 2 is pseudo-code for hybrid condition encoder-decoder processing of sensor data, in accordance with an embodiment of the present invention;

FIG. 3 is pseudo-code for temporal clustering, in accordance with an embodiment of the present invention;

FIG. 4 is pseudo-code for sensor embedding, in accordance with an embodiment of the present invention;

FIG. 5 is pseudo-code for generating a sequence reconstruction, in accordance with an embodiment of the present invention;

FIG. 6 is a block diagram of the interrelationships between condition sensor information and key performance indicator (KPI) sensor information, in accordance with an embodiment of the present invention;

FIG. 7 is a block diagram of an encoder/decoder model for sequence reconstruction, in accordance with an embodiment of the present invention;

FIG. 8 is a block/flow diagram of a method for training an encoder/decoder model, in accordance with an embodiment of the present invention;

FIG. 9 is a block diagram of a computer system that can perform hidden state identification, model training, and anomaly detection, in accordance with an embodiment of the present invention;

FIG. 10 is a diagram of a neural network architecture that can be used as part of a hidden condition detection model, in accordance with an embodiment of the present invention;

FIG. 11 is a diagram of a deep neural network architecture that can be used as a part of a hidden condition detection model, in accordance with an embodiment of the present invention; and

FIG. 12 is a block/flow diagram of a method for performing anomaly detection, sensitive to hidden condition of a system, in accordance with an embodiment of the present invention.

### DETAILED DESCRIPTION OF PREFERRED EMBODIMENTS

Cyber-physical systems may include a large number of sensors that monitor the working status of the system. However, the system may have hidden status conditions that are not directly measured by the sensors, but that guide the overall behavior of the system and that may impact the measurements of multiple sensors. Without having direct information of these hidden status conditions, it can be difficult to identify the system's normal dynamics, and this may in turn make it difficult to identify abnormal behavior correctly.

Hidden status conditions may be caused by, e.g., changes in user operation or system state changes. Users can rarely provide accurate information about these hidden status conditions. Additionally, the behavior and corresponding dynamic of the hidden status condition across different users may be different, making it difficult to discern what the relevant hidden status condition is.

A hybrid condition encoder-decoder model can be used to recover hidden status conditions and to detect abnormal or failure events from multivariate sensor data. Deep temporal clustering may be used to distinguish the hidden conditions. To capture the smooth switching of hidden conditions and corresponding intermediate conditions, a similarity-based mechanism can be used to discover hybrid conditions and decompose them to basic hidden conditions. For each basic hidden condition, an encoder-decoder network is used to product a preliminary embedding presentation, where the encoder learns the embedding vector presentation of the multivariate time series and the decoder reconstructs the original sequence. Based on the hybrid condition and the encoding embedding features, a neural network may be used to reconstruct the sequence and the reconstruction error may be used to determine a likelihood that an anomaly has occurred. The present embodiments may operate on systems with multiple and complex conditions and operational models, and may be trained using only data collected during normal operation of the system.

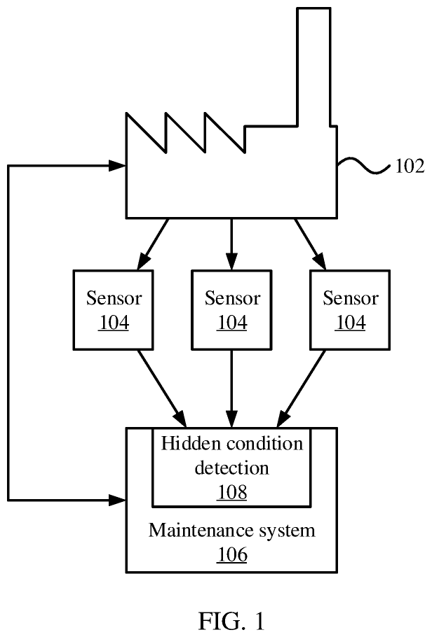

Referring now in detail to the figures in which like numerals represent the same or similar elements and initially to FIG. 1, a maintenance system 106 in the context of a monitored system 102 is shown. The monitored system 102 can be any appropriate system, including physical systems such as manufacturing lines and physical plant operations, electronic systems such as computers or other computerized devices, software systems such as operating systems and applications, and cyber-physical systems that combine physical systems with electronic systems and/or software systems. Exemplary systems 102 may include a wide range of different types, including railroad systems, power plants, vehicle sensors, data centers, satellites, and transportation systems. Another type of cyber-physical system can be a network of internet of things (IoT) devices, which may include a wide variety of different types of devices, with various respective functions and sensor types.

One or more sensors 104 record information about the state of the monitored 416 system 102. The sensors 104 can be any appropriate type of sensor including, for example, physical sensors, such as temperature, humidity, vibration, pressure, voltage, current, magnetic field, electrical field, and light sensors, and software sensors, such as logging utilities installed on a computer system to record information regarding the state and behavior of the operating system and applications running on the computer system. The sensor data may include, e.g., numerical data and categorical or binary-valued data. The information generated by the sensors 104 can be in any appropriate format and can include sensor log information generated with heterogeneous formats.

The sensors 104 may transmit the logged sensor information to an anomaly maintenance system 106 by any appropriate communications medium and protocol, including wireless and wired communications. The maintenance system 106 can, for example, identify abnormal or anomalous behavior by monitoring the multivariate time series that are generated by the sensors 104. Once anomalous behavior has been detected, the maintenance system 106 communicates with a system control unit to alter one or more parameters of the monitored system 102 to correct the anomalous behavior.

Exemplary corrective actions include changing a security setting for an application or hardware component, changing an operational parameter of an application or hardware component (for example, an operating speed), halting and/or restarting an application, halting and/or rebooting a hardware component, changing an environmental condition, changing a network interface's status or settings, etc. The maintenance system 106 thereby automatically corrects or mitigates the anomalous behavior. By identifying the particular sensors 104 that are associated with the anomalous classification, the amount of time needed to isolate a problem can be decreased.

Each of the sensors 104 outputs a respective time series, which encodes measurements made by the sensor over time. For example, the time series may include pairs of information, with each pair including a measurement and a timestamp, representing the time at which the measurement was made. Each time series may be divided into segments, which represent measurements made by the sensor over a particular time range. Time series segments may represent any appropriate interval, such as one second, one minute, one hour, or one day. Time series segments may represent a set number of collection time points, rather than a fixed period of time, for example covering 100 measurements.

The maintenance system 106 therefore includes a model that may be trained to handle numerical and categorical data. For a complicated system 106, the number of sensors 104 may be very large, with the sensors reporting independent streams of time-series data. Hidden conditions in such a system 106 may govern the interrelationships between sensor measurements in ways that are difficult to predict. A hidden condition detection 108 therefore aids in detecting and correcting anomalies.

Sensors 104 may collect information about conditions of the system 106, such as information that relates to system control and operation mode. Sensors 104 may also collect information relating to key performance indicators (KPIs) such as temperature, humidity, motion, and pressure to characterize the system health and key parameters. Monitoring for anomalies may be conducted on information from the KPI sensors, but the values of the KPI sensors are influenced by the information generated by the condition sensors.

For example, the condition sensor may reflect how high of a workload is being performed by the system 106. During periods of high load, the KPI sensors may register higher values, while during periods of low load, the KPI sensors may register lower values. If anomaly detection is not adjusted for these different operational states, it may mistakenly report certain data points as anomalous, when they are actually within normal operating parameters. Conversely, anomaly detection may fail to recognize anomalies that occur during certain operational states, when the normal dynamic of the KPIs is different.

Training may be performed using a historical dataset [symbol] ={X₁, . . . , Xₙ}, with n different sensor data instances. Each sensor data instance Xₜ∈ [symbol] ^{d×T} is a multivariate time series with length T and, for each time step 1≤t≤T, X_{i,t}=[Cᵢ, S_{i,t}]∈ [symbol] ^{d}^{₁}^{+d}^{₂} is the corresponding multivariate vector with dimension d=d₁+d₂. Here S_{i,t}∈ [symbol] ^{d}^{₂} is numerical data collected from KPI measurements. The terms d₁ and d₂ refer to the sizes of state sensors and KPI sensors, respectively.

Anomaly detection may be divided into two categories: point anomalies and contextual anomalies. Point anomalies correspond to data points that are significantly different from expected behavior across an entire trajectory. Examples of point anomalies in the context of a vehicle's operation may include sudden and significant increases or decreases in speed, abrupt changes in steering direction, and extreme acceleration or deceleration.

In comparison, contextual anomalies are data points that are significantly different from the expected behavior within a specific context or environment, and which can only be identified by taking the environment into account. For example, a sudden and significant increase of speed during a sharp turn or when approaching a school zone could be considered a contextual anomaly, as it deviates from expected behavior within the context of the driving situation. In general, contextual anomalies may be more difficult to detect than point anomalies.

KPI sensor data may include fluctuations from the system 106 or from the external environment. The corresponding noise may distort similarities between the KPI measurements. Additionally, although KPI data may often be periodic, the period length on a given system may have differences between respective sensors 104, leading to a lag in the period. Since KPIs have an explicit or explicit association in phase shift, these phase shifts can make it challenging to predict the dynamics of a given KPI sensor.

KPIs may further differ significantly across different operational states or working environments. For example, processor or memory usage in a computer system may be high and unstable with high request frequencies and may decrease when accesses are less frequent. External factors that are not related to the system status may nonetheless influence the sensor data, even during a normal operating state. To incorporate external information, contextual variables C_{i,t}∈ [symbol] ^{d}^{₁} denote state attributes which indicate the dynamic of the operational state or working environment.

The causes of external information {C₁, . . . , Cₙ} may be disregarded and their state attributes may be assumed to represent normal operation. In addition, most of the time series in the training dataset {S₁, . . . , Sₙ} may be considered normal with respect to the external information. A model [symbol] may be learned, such that when a new time series X arrives, the model can accurately detect whether the time series X is normal or abnormal, including but not limited to detecting abnormality in noise or phase shift.

Due to the high dimensionality of the external information, there may exist fringe time series and isolated time series. The model [symbol] may omit such rarely visited states of the system. A confidence score may be derived for a detected anomaly which captures the uncertainty in a prediction.

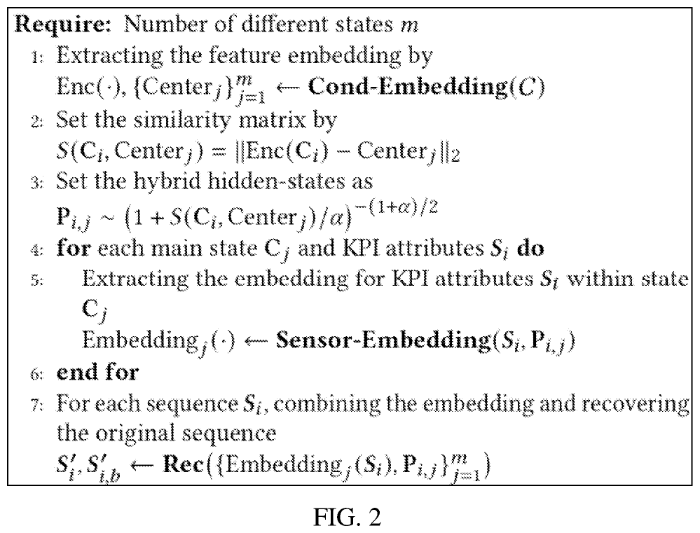

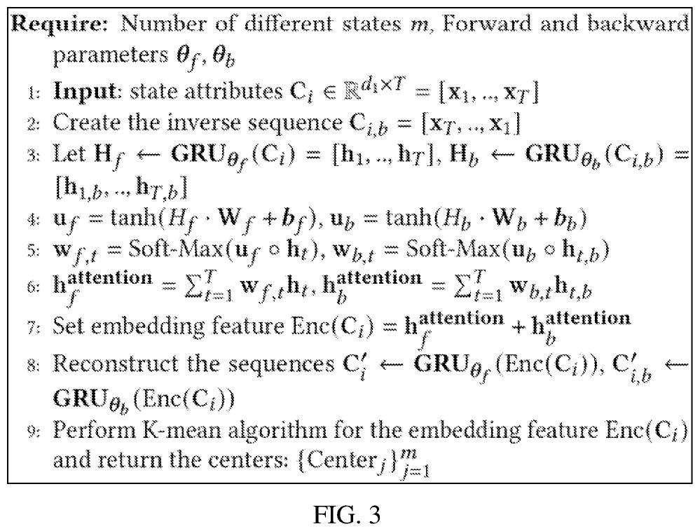

Referring now to FIG. 2, pseudo-code for hybrid condition encoder-decoder processing of sensor data is shown. In the first line, an autoencoder-based deep temporal clustering may be used to distinguish the hidden state from state attributes C={C₁, . . . , Cₙ} where each clustering center corresponds to a different system state. Additional information on clustering Cond-Embedding is described below with respect to FIG. 3.

Given the input sequence Cᵢ, sequential gated recurrent unit (GRU) neural network cells may be used as an encoder to extract time-series information from both the forward sequence Cᵢ and the corresponding inverse sequence C_{i,b}. After receiving feature embedding matrices H_{f}, H_{b}∈ [symbol] ^{T×l}, the attention mechanism is introduced to aggregate the feature across different timestamps. The subscripts f and b refer to “forward” and “backward,” and Cᵢ is the i^{th} state sensor's reading in a time series. Thus, if there are n state sensors in the dataset, Cᵢ is the time series from the i^{th} sensor, with the f subscript being omitted. Both forward and backward sequences are used because neural networks may be sensitive to the order of sequences. The use of both directions of the sequences helps to catch all the relations and patterns in the training data.

Based on the final embedding feature Enc(Cᵢ), the original sequence may be reconstructed with a GRU-based decoder. K-means clustering is performed with the embedding feature to generate clusters. Based on the reconstruction error and the clustering error, the training loss may include three parts, including an autoencoder forward loss, an autoencoder backward loss, and a K-means loss:

$$Loss = α \cdot {\sum }_{i = 1}^{n} {‖ {C}_{i} - {C}_{i}^{′} ‖}_{2}^{2} + α \cdot {\sum }_{i = 1}^{n} {‖ {C}_{i , b} - {C}_{i , b}^{′} ‖}_{2}^{2} + β \cdot {\sum }_{i = 1}^{n} {‖ Enc ( {C}_{i} ) - Center ( Enc ( {C}_{i} ) ) ‖}_{2}^{2}$$

where Center(Enc(Cᵢ)) corresponds to the closest center for feature embedding Enc(Cᵢ) and α and β are two hyper-parameters, with a being the weight of the reconstructed sequence errors and with β being the weight of the distance from the individual embedding to its closest clustering center. The training loss is minimized and the parameters θ_{f} and θ_{b} may be updated with a gradient descent.

Referring now to FIG. 3, pseudo-code for temporal clustering Cond-Embedding is shown. The time series Xᵢ may not fall into a particular hidden state Centerⱼ, and the smooth dynamic of the hidden state and the existence of some intermediate state may make it difficult to detect abnormal events. To capture smoothly changing hidden states and corresponding intermediate states, a similarity-based approach may be used to discover hybrid states and to decompose each time series Xᵢ to the hybrid of multiple basic hidden states. For each time series Xᵢ, the state attributes Cᵢ may be used to extract feature embedding Enc(Cᵢ).

A similarity may be determine for state attributes Cᵢ and hidden state Centerⱼ as the Euclidean distance between Enc(Cᵢ) and Centerⱼ: S (Cᵢ, Centerⱼ)=∥Enc(Cᵢ)−Centerⱼ∥₂. The hybrid state is constructed with the Student's t distribution to generate weight matrix P_{i,j}˜(1+S(Cᵢ, Centerⱼ)/α)^{-(1-α)/2}, where wᵢⱼ represents the probability to assign state series Cᵢ to main state Centerⱼ. Using the weighted matrix P, the hidden state for series Xᵢ can be decomposed as a hybrid of main states.

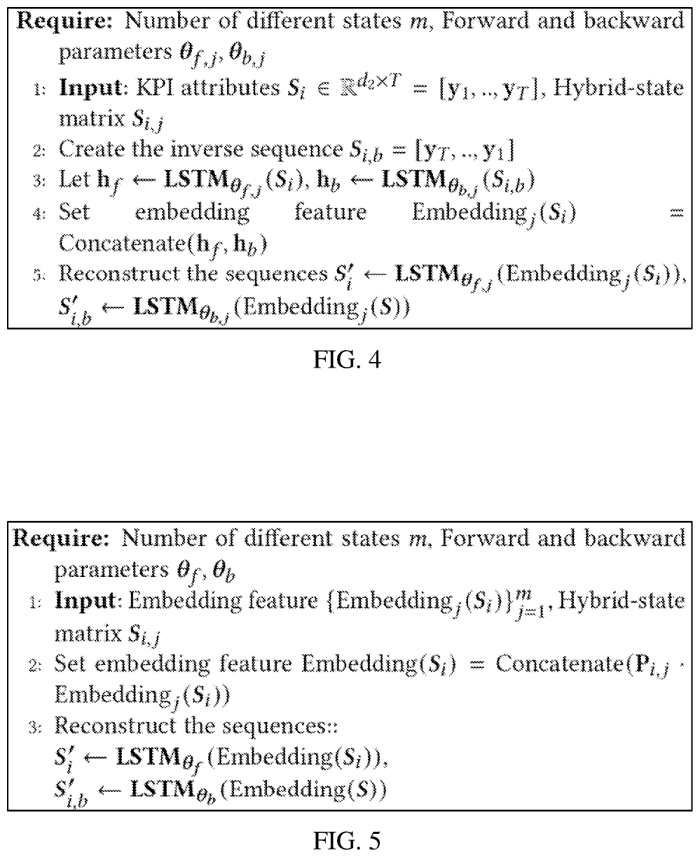

Referring now to FIG. 4, pseudo-code for sensor embedding is shown. An encoder may be used to extract features from a KPI sequence Sᵢ. The performance across different states can vary widely, and the features may need to collect a variety of different types of information, such as period and magnitude, across the different main states. Individual encoders and decoders may therefore be trained for each main state Centerⱼ separately.

The encoder may include two different units based on long-short term memory (LSTM) neural network structures to process the KPI series. A first such unit aggregates the time-series information from the forward sequence and the second such unit focuses on the backward sequence. After concatenating the output of the two different units h f and h_{b}, the encoding feature Embedding gₖ(Sᵢ) and feed it to the decoder to reconstruct the original sequence.

Since each time series Sᵢ may not belong solely to one main state Centerⱼ, the reconstruction error for each main state may also be weighted by the hybrid-state matrix as:

$${Loss}_{j} = {\sum }_{i = 1}^{n} {P}_{i , j} {‖ {S}_{i} - {S}_{i}^{′} ‖}_{2}^{2} + {\sum }_{i = 1}^{n} {P}_{i , j} {‖ Si , b - {S}_{i , b}^{′} ‖}_{2}^{2}$$

The loss function may include a hybrid autoencoder forward loss term and a hybrid autoencoder backward loss term. Gradient descent may be used to update the parameters θ_{f,j} and θ_{b,j} for the main state Centerⱼ to minimize the loss for each state.

Referring now to FIG. 5, pseudo-code for generating a sequence reconstruction is shown. For each of the KPI attributes Sᵢ, the feature Embeddingⱼ(Sᵢ) may be concatenated with the hybrid-state matrix. The concatenated output is used as input to the LSTM-based decoder to reconstruct the original sequence. The parameter may be updated with gradient descent to minimize the following reconstruction loss:

$$Loss = {\sum }_{i = 1}^{n} {‖ {S}_{i} - {S}_{i}^{′} ‖}_{2}^{2} + {\sum }_{i = 1}^{n} {P}_{i , j} {‖ Si , b - {S}_{i , b}^{′} ‖}_{2}^{2}$$

which may include a forward reconstruction error and a backward reconstruction error.

After training the framework, the state-specific model can be combined to detect the anomaly events for the online sequence X=[C, S]. As with the training, the anomaly detection may also include four different stages. In the first stage, the deep temporal lustering may be implied with the state series C and the state-embedding vector Enc(C) may be generated. The similarity matrix may be used to compute the Euclidean distance between Enc(C) and each main state Centerⱼ. The hybrid hidden states may be discovered with Student's t distribution.

In the third step, the KPI sequence S may be encoded for each main state and features {Embeddingⱼ(S)}ⱼ₌₁^{m} may be generated. The original KPI series may be reconstructed as S′ and S′_{b}. The reconstruction error may be used as the anomaly score, and an alert may be generated for the anomaly if the anomaly score exceeds a threshold. A confidence score can be determined based on the distribution of the hybrid hidden states.

The confidence score may be determined based on the distance of an embedding of streaming data, Enc(C), to its closest clustering center, Enc(Cᵢ). For example, the confidence score may be computed as:

Score(C)=max(1, avg_dist_training/dist(Enc(C),Enc(Centerⱼ)))

In this expression, C is the dataset from state sensors of incoming data for testing, Enc(C) is the embedding features of C, and Enc(Centerⱼ) is the embedding of the closest clustering center to Enc(C). The term avg_dist_training is the average distance of the training samples to their clustering center. If the distance between C and its closest center is smaller than the average in training samples, then the score reaches a maximum of 1. The system produces high confidence scores, because C already belongs to an existing cluster. If the distance is larger than the average training distance, then the testing sample is far from an existing cluster, and the confidence score will be lower based on the value of the distance.

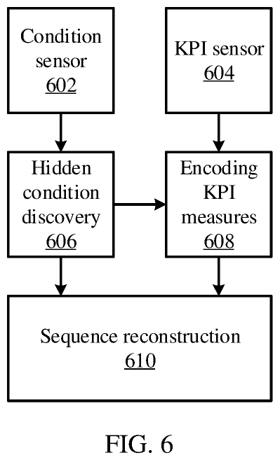

Referring now to FIG. 6, a process/system for training the hybrid condition encoder-decoder is shown. Condition sensors 602 measures condition information for the system 106 and KPI sensors 604 measure KPI information. Hybrid hidden condition discovery 606 takes the condition sensor data as input and conducts unsupervised clustering to find the major cluster centers. These cluster centers are tagged as major conditions.

KPI measures from the KPI sensors 604 are encoded 608 by an encoder of the model. For each major condition identified from the condition discovery 606, the model retrieves key features from the KPI sensors 604. This information may be used to train a model to profile the normal state of the system 106 under such conditions.

Sequence reconstruction 610 uses the retrieved features and the hidden condition (e.g., expressed as a vector that identifies the probabilities that the system is in the respective conditions) to reconstruct the KPI sensor data with a decoder of the model. During training, parameters of the encoder and decoder are adjusted to minimize the reconstruction loss, as described above, using a gradient descent. The resulting models include a probability model for hidden condition determination and encoding feature models for each major condition.

The parameters of the model can be trained in an ongoing fashion, based on newly collected sensor information. Condition sensor data is processed and applied to the hidden condition determination model. This may be used to update a probability matrix to represent the likelihoods of the system 106 under each major condition. The features of each major condition may be integrated by weights of the probability matrix and may be used to reconstruct the KPI sensor data. An anomaly score may be computed during this online processing based on the difference between the newly collected sensor data and the reconstructed data.

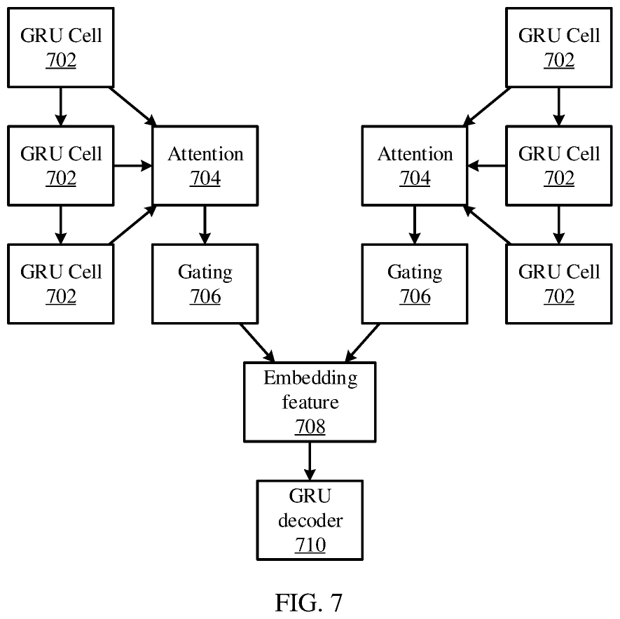

Referring now to FIG. 7, a diagram of an encoder-decoder architecture is shown. A set of GRU cells 702 extracts feature embeddings from condition attributes and an attention 704 combines the features together across different timestamps. This is done in a forward and backward fashion, with respective gating mechanisms 706, and the features are combined to form embedding feature 708. Thus the encoder may include distinct branches for forward processing and backward processing of a sequence. A GRU-based decoder 710 may be used to reconstruct the original condition attributes for clustering.

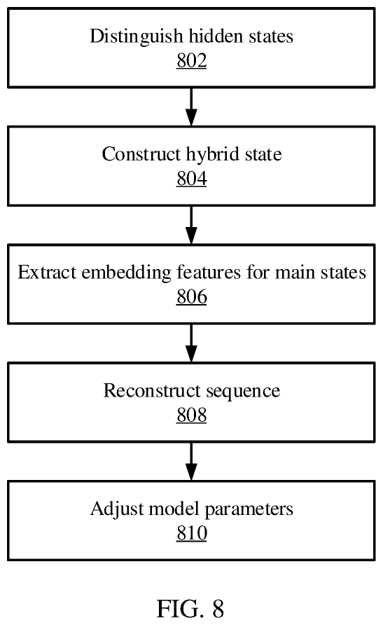

Referring now to FIG. 8, a training method for the hybrid condition encoder-decoder model is shown. Block 802 distinguishes hidden states, for example by clustering condition information as described above. The obtained cluster centers identify different conditions that a system may operate in, and are used in block 804 to construct a hybrid state of main states.

Block 806 extracts the embedding feature of each of the main states, for example using an LSTM encoder. Block 808 then reconstructs the original sequence using the hybrid hidden state using a decoder. Block 810 can then use the difference between the original sequence and the reconstruction to guide the alteration of model parameters using a gradient descent.

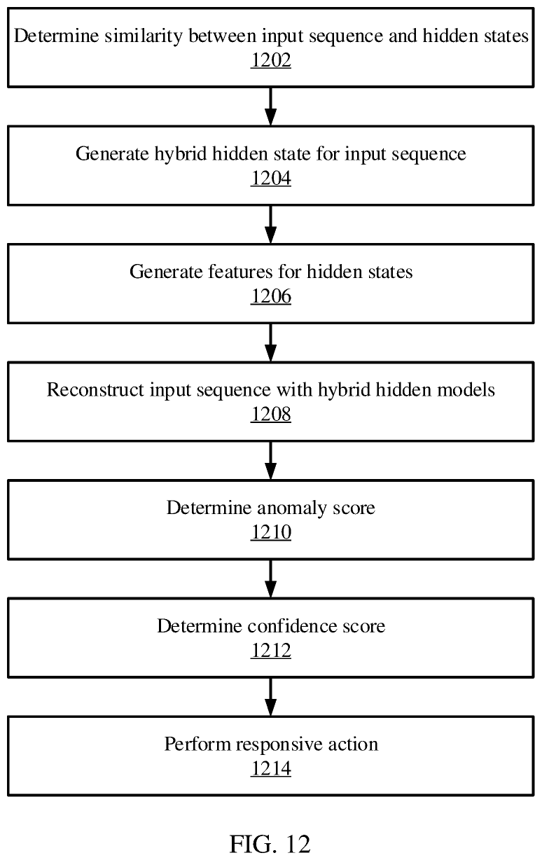

Referring now to FIG. 12, a method for anomaly detection is shown. Block 1202 determines a similarity between a new input sequence, collected from sensors 104, and hidden states of the system. Block 1204 generates a hybrid hidden state for the input sequence, based on a distance between an embedded version of the input sequence and respective cluster centers for the different hidden states. Block 1206 generates features for the hidden states of the input sequence.

Block 1208 uses the trained decoder to reconstruct the input sequence with hybrid hidden models. A reconstruction error, based on a comparison between the reconstruction and the input sequence, can be used as an anomaly score in block 1210. A confidence score may be determined based on a distance from cluster centers in block 1212. Based on the anomaly score and the confidence score (e.g., if both scores are above respective threshold values), block 1214 performs a corrective action to respond to a detected anomaly.

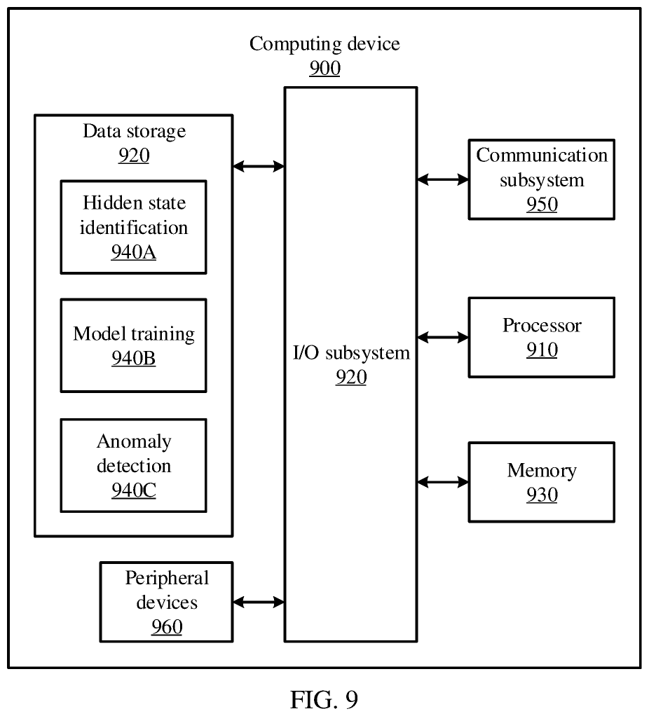

Referring now to FIG. 9, an exemplary computing device 900 is shown, in accordance with an embodiment of the present invention. The computing device 900 is configured to perform named entity recognition.

The computing device 900 may be embodied as any type of computation or computer device capable of performing the functions described herein, including, without limitation, a computer, a server, a rack based server, a blade server, a workstation, a desktop computer, a laptop computer, a notebook computer, a tablet computer, a mobile computing device, a wearable computing device, a network appliance, a web appliance, a distributed computing system, a processor-based system, and/or a consumer electronic device. Additionally or alternatively, the computing device 900 may be embodied as one or more compute sleds, memory sleds, or other racks, sleds, computing chassis, or other components of a physically disaggregated computing device.

As shown in FIG. 9, the computing device 900 illustratively includes the processor 910, an input/output subsystem 920, a memory 930, a data storage device 940, and a communication subsystem 950, and/or other components and devices commonly found in a server or similar computing device. The computing device 900 may include other or additional components, such as those commonly found in a server computer (e.g., various input/output devices), in other embodiments. Additionally, in some embodiments, one or more of the illustrative components may be incorporated in, or otherwise form a portion of, another component. For example, the memory 930, or portions thereof, may be incorporated in the processor 910 in some embodiments.

The processor 910 may be embodied as any type of processor capable of performing the functions described herein. The processor 910 may be embodied as a single processor, multiple processors, a Central Processing Unit(s) (CPU(s)), a Graphics Processing Unit(s) (GPU(s)), a single or multi-core processor(s), a digital signal processor(s), a microcontroller(s), or other processor(s) or processing/controlling circuit(s).

The memory 930 may be embodied as any type of volatile or non-volatile memory or data storage capable of performing the functions described herein. In operation, the memory 930 may store various data and software used during operation of the computing device 900, such as operating systems, applications, programs, libraries, and drivers. The memory 930 is communicatively coupled to the processor 910 via the I/O subsystem 920, which may be embodied as circuitry and/or components to facilitate input/output operations with the processor 910, the memory 930, and other components of the computing device 900. For example, the I/O subsystem 920 may be embodied as, or otherwise include, memory controller hubs, input/output control hubs, platform controller hubs, integrated control circuitry, firmware devices, communication links (e.g., point-to-point links, bus links, wires, cables, light guides, printed circuit board traces, etc.), and/or other components and subsystems to facilitate the input/output operations. In some embodiments, the I/O subsystem 920 may form a portion of a system-on-a-chip (SOC) and be incorporated, along with the processor 910, the memory 930, and other components of the computing device 900, on a single integrated circuit chip.

The data storage device 940 may be embodied as any type of device or devices configured for short-term or long-term storage of data such as, for example, memory devices and circuits, memory cards, hard disk drives, solid state drives, or other data storage devices. The data storage device 940 can store program code 940A for hidden state identification, 940B for model training, and/or 940C for anomaly detection. Any or all of these program code blocks may be included in a given computing system. The communication subsystem 950 of the computing device 900 may be embodied as any network interface controller or other communication circuit, device, or collection thereof, capable of enabling communications between the computing device 900 and other remote devices over a network. The communication subsystem 950 may be configured to use any one or more communication technology (e.g., wired or wireless communications) and associated protocols (e.g., Ethernet, InfiniBand®, Bluetooth®, Wi-Fi®, WiMAX, etc.) to effect such communication.

As shown, the computing device 900 may also include one or more peripheral devices 960. The peripheral devices 960 may include any number of additional input/output devices, interface devices, and/or other peripheral devices. For example, in some embodiments, the peripheral devices 960 may include a display, touch screen, graphics circuitry, keyboard, mouse, speaker system, microphone, network interface, and/or other input/output devices, interface devices, and/or peripheral devices.

Of course, the computing device 900 may also include other elements (not shown), as readily contemplated by one of skill in the art, as well as omit certain elements. For example, various other sensors, input devices, and/or output devices can be included in computing device 900, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 900 are readily contemplated by one of ordinary skill in the art given the teachings of the present invention provided herein.

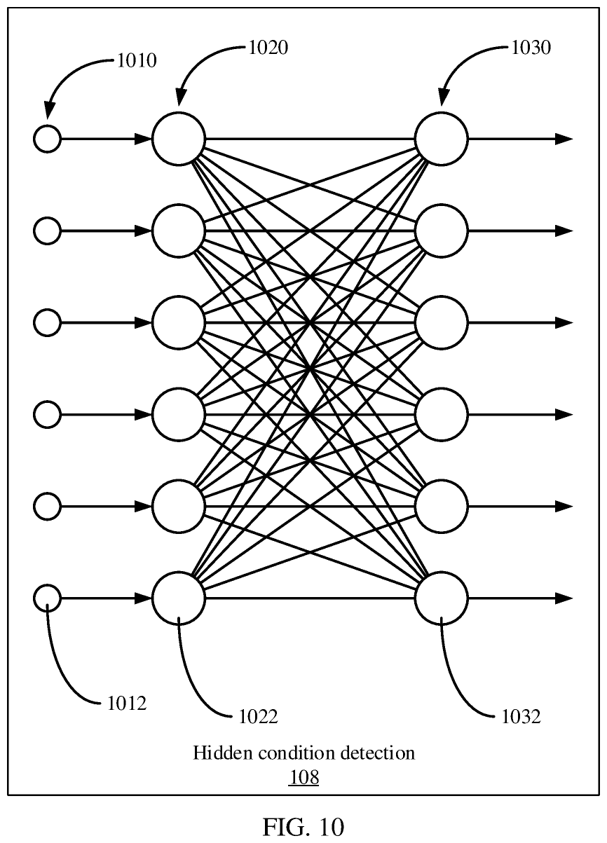

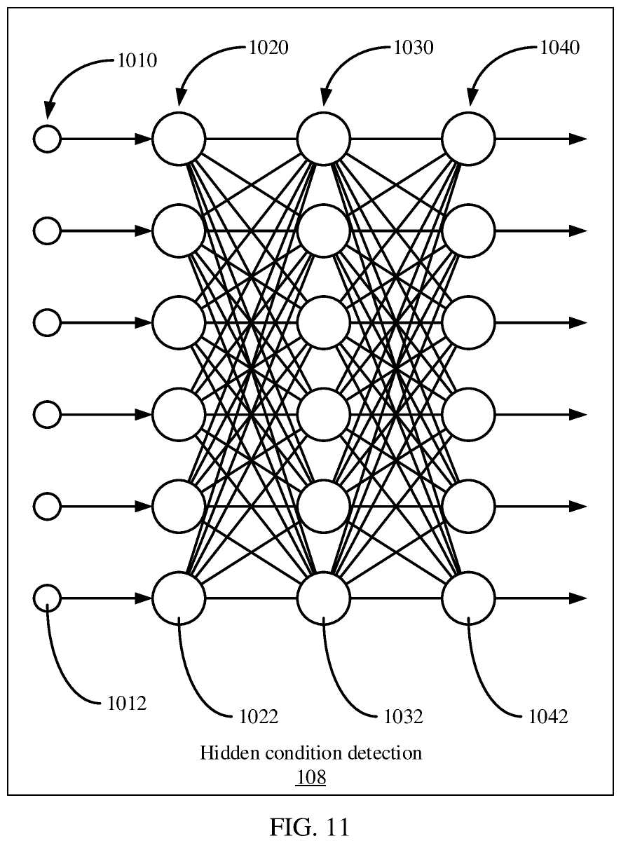

Referring now to FIGS. 10 and 11, exemplary neural network architectures are shown, which may be used to implement parts of the present models, such as the hidden condition detection 108. A neural network is a generalized system that improves its functioning and accuracy through exposure to additional empirical data. The neural network becomes trained by exposure to the empirical data. During training, the neural network stores and adjusts a plurality of weights that are applied to the incoming empirical data. By applying the adjusted weights to the data, the data can be identified as belonging to a particular predefined class from a set of classes or a probability that the inputted data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

In layered neural networks, nodes are arranged in the form of layers. An exemplary simple neural network has an input layer 1020 of source nodes 1022, and a single computation layer 1030 having one or more computation nodes 1032 that also act as output nodes, where there is a single computation node 1032 for each possible category into which the input example could be classified. An input layer 1020 can have a number of source nodes 1022 equal to the number of data values 1012 in the input data 1010. The data values 1012 in the input data 1010 can be represented as a column vector. Each computation node 1032 in the computation layer 1030 generates a linear combination of weighted values from the input data 1010 fed into input nodes 1020, and applies a non-linear activation function that is differentiable to the sum. The exemplary simple neural network can perform classification on linearly separable examples (e.g., patterns).

A deep neural network, such as a multilayer perceptron, can have an input layer 1020 of source nodes 1022, one or more computation layer(s) 1030 having one or more computation nodes 1032, and an output layer 1040, where there is a single output node 1042 for each possible category into which the input example could be classified. An input layer 1020 can have a number of source nodes 1022 equal to the number of data values 1012 in the input data 1010. The computation nodes 1032 in the computation layer(s) 1030 can also be referred to as hidden layers, because they are between the source nodes 1022 and output node(s) 1042 and are not directly observed. Each node 1032, 1042 in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . , wₙ₋₁, wₙ. The output layer provides the overall response of the network to the inputted data. A deep neural network can be fully connected, where each node in a computational layer is connected to all other nodes in the previous layer, or may have other configurations of connections between layers. If links between nodes are missing, the network is referred to as partially connected.

Training a deep neural network can involve two phases, a forward phase where the weights of each node are fixed and the input propagates through the network, and a backwards phase where an error value is propagated backwards through the network and weight values are updated.

The computation nodes 1032 in the one or more computation (hidden) layer(s) 1030 perform a nonlinear transformation on the input data 1012 that generates a feature space. The classes or categories may be more easily separated in the feature space than in the original data space.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for training a model, comprising:
distinguishing hidden states of a monitored system based on condition information;
generating an encoder and decoder for each respective hidden state using forward and backward autoencoder losses;
determining a hybrid hidden state for an input sequence based on the hidden states;
reconstructing the input sequence using the encoders and decoders and the hybrid hidden state; and
updating parameters of the encoders and decoders based on a reconstruction loss.

2. The method of claim 1, wherein distinguishing the hidden states includes an unsupervised clustering of the condition information to generate clusters, with a center of each cluster being a respective hidden state.

3. The method of claim 1, wherein the encoders and the decoders are neural network models that include gated recurrent units (GRUs).

4. The method of claim 3, wherein the encoder includes distinct forward-processing and backward-processing branches, with each branch having a respective set of GRUs.

5. The method of claim 1, wherein determining the hybrid hidden state includes determining a respective similarity between the input sequence and each of the hidden states.

6. The method of claim 1, wherein determining the hybrid state uses Student's t distribution to generate a weight matrix that decomposes the input sequence into the hidden states.

7. The method of claim 1, wherein the input sequence is a multivariate time series sequence, made up of measurements from a plurality of key performance indicator (KPI) sensors and wherein the condition information includes a measurement from a system condition sensor that is distinct from the KPI sensors.

8. The method of claim 1, wherein the condition information includes an indication of system workload.

9. A system for training a model, comprising:
a hardware processor; and
a memory that stores a computer program which, when executed by the hardware processor, causes the hardware processor to:
distinguish hidden states of a monitored system based on condition information;
generate an encoder and decoder for each respective hidden state using forward and backward autoencoder losses;
determine a hybrid hidden state for an input sequence based on the hidden states;
reconstruct the input sequence using the encoders and decoders and the hybrid hidden state; and
update parameters of the encoders and decoders based on a reconstruction loss.

10. The system of claim 9, wherein the computer program further causes the hardware processor to perform an unsupervised clustering of the condition information to generate clusters, with a center of each cluster being a respective hidden state.

11. The system of claim 9, wherein the encoders and the decoders are neural network models that include gated recurrent units (GRUs).

12. The system of claim 11, wherein the encoder includes distinct forward-processing and backward-processing branches, with each branch having a respective set of GRUs.

13. The system of claim 9, wherein the computer program further causes the hardware processor to determine a respective similarity between the input sequence and each of the hidden states.

14. The system of claim 9, wherein the determination of the hybrid state uses Student's t distribution to generate a weight matrix that decomposes the input sequence into the hidden states.

15. The system of claim 9, wherein the input sequence is a multivariate time series sequence, made up of measurements from a plurality of key performance indicator (KPI) sensors and wherein the condition information includes a measurement from a system condition sensor that is distinct from the KPI sensors.

16. The system of claim 9, wherein the condition information includes an indication of system workload.

17. A computer-implemented method for anomaly detection, comprising:
generating a hybrid hidden state for an input sequence relative to a plurality of hidden states of a system;
reconstructing the input sequence using a decoder, based on the hybrid hidden state;
determining an anomaly score based on a reconstruction error between the input sequence and the reconstructed input sequence; and
performing a corrective action responsive to the anomaly score.

18. The method of claim 17, further comprising determining a confidence score based on a distance between the input sequence and cluster centers of the plurality of hidden states.

19. The method of claim 18, wherein performing the corrective action is further performed responsive to the confidence score.

20. The method of claim 17, wherein the corrective action is selected from the group consisting of changing a security setting for an application or hardware component, changing an operational parameter of an application or hardware component, halting or restarting an application, halting or rebooting a hardware component, changing an environmental condition, and changing a network interface's status or settings.
